(19) United States
(12) Patent Application Publication
(10) Pub. No.: US 2026/0240159 A1
(43) Pub. Date: Aug. 20, 2026

(54) HERBICIDAL COMPOSITIONS

(71) Applicant: SYNGENTA CROP PROTECTION AG, Basel (CH)

(72) Inventors: Julia FELLMANN, Basel (CH); Melanie Jayne WATKINS, Bracknell, Berkshire (GB)

(73) Assignee: SYNGENTA CROP PROTECTION AG, Basel (CH)

(21) Appl. No.: 19/159,275

(22) PCT Filed: Feb. 15, 2025
(86) PCT No.: PCT/EP2024/053930

§ 371 Date: Aug. 22, 2025

(30) Foreign Application Priority Data
Feb. 24, 2023 (EP) 23158615.7

(51) Int. Cl. A01N 43/80; A01N 37/26; A01P 13/02

(52) U.S. Cl. CPC A01N 43/80; A01N 37/26; A01P 13/02

(57) ABSTRACT

The present invention relates to a herbicidal composition comprising a mixture of components (A) and (B) as active ingredients, wherein component (A) is a compound of formula (I) and component (B) is S-metolachlor or agrochemically acceptable ester or salt thereof.

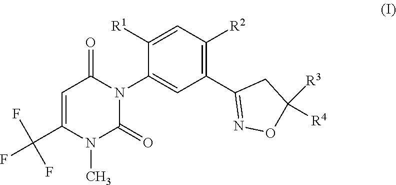

The present invention relates to novel herbicidal compositions comprising a combination of herbicidal active ingredients which provides control of weeds in crops of useful plants. The invention further provides methods of controlling weeds in crops of useful plants, and to the use of the herbicidal composition to control weeds. Compounds of Formula (I)

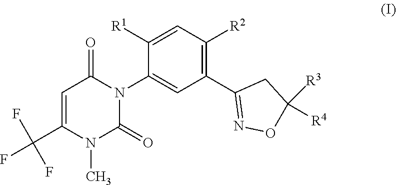

are known from WO2016/095768 and provide effective control of problematic weeds in crops. WO2020/063613 provides a further process for making such compounds.

Combinations of herbicidal active ingredients are often used in agriculture to increase and/or broaden the control of problematic plants (weeds) in crops of useful plants. In some instances, the combination can give rise to a valuable greater-than-additive (synergistic) effect which can, for example, enable efficient weed control through lower application rates. The present invention is based upon novel compositions comprising compounds of Formula (I).

Thus, according to the present invention there is provided a herbicidal composition comprising (A) a herbicidally effective amount of a compound of Formula (I):

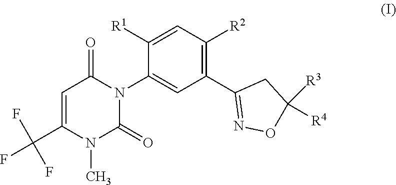

wherein
R¹ is selected from hydrogen, chloro and fluoro;
R² is selected from chloro and bromo;
R³ is selected from CO₂R⁵ and CH₂OR⁶;
R⁴ is selected from H, CH₃— and CH₃CH₂—;
R⁵ is selected from H, CH₃—, CH₃CH₂—, CH₃CH₂CH₂—, CH₃CH₂CH₂CH₂—, (CH₃)₂CH—, (CH₃)₂CHCH₂—, (CH₃)₃C—, CF₃CH₂—, allyl, propargyl, CH₃OCH₂CH₂—, C₂H₅OCH₂CH₂—, CH₃CO₂CH₂CH₂— and tetrahydrofuranmethyl;
R⁶ is selected from C₁-C₄alkylcarbonyl, cyclopropylcarbonyl, and C₁-C₂alkylsulfonyl;
or agrochemically acceptable salt thereof;
and component (B) is S-metolachlor or agrochemically acceptable ester or salt thereof.

EP77755B1 describes S-metolachlor and processes for making it.

An object of the present invention is to provide alternative and/or improved herbicidal mixtures which are highly effective against various weed species (particularly at low dose), and is based on the finding that compounds of Formula (I) in combination with S-metolachlor, are particularly efficacious in controlling weeds.

In a preferred embodiment of the present invention, component (A) is a compound of formula (I), wherein
R¹ is selected from chloro and fluoro; preferably R¹ is fluoro;
R² is selected from chloro and bromo; preferably R² is chloro;
R³ is CO₂R⁵;
R⁴ is selected from H, CH₃ and CH₃CH₂—; preferably R⁴ is CH₃—, R⁵ is selected from H, CH₃, CH₃CH₂—, CH₃CH₂CH₂—, CH₃CH₂CH₂CH₂—, (CH₃)₂CH—, (CH₃)₂CHCH₂—, and (CH₃)₃C—; preferably R⁵ is CH₃CH₂—.

In a more preferred embodiment of the present invention, the compound of Formula (I) is a compound of Formula (Ia).

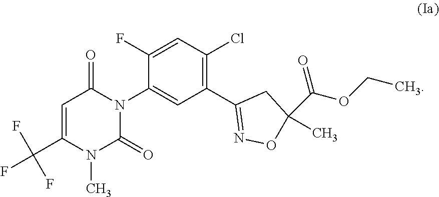 [SMILES: CCOC(=O)C1(C)CC(c2cc(-n3c(=O)cc(C(F)(F)F)n(C)c3=O)c(F)cc2Cl)=NO1]

In a preferred composition according to the invention, the weight ratio of component (A) to component (B) is from 1:1 to 1:150.

In a more preferred composition according to the invention, the weight ratio of component (A) to component (B) is from 1:8 to 1:150.

In an even more preferred composition according to the invention, the weight ratio of component (A) to component (B) is from 1:10 to 1:140.

In a second aspect of the present invention there is provided a herbicidal composition according to the invention further comprising at least one additional pesticide.

In a preferred composition according to the second aspect of the present invention the additional pesticide is a herbicide or herbicide safener.

In a more preferred composition according to the second aspect of the present invention the additional pesticide is a herbicide selected from the group consisting of paraquat dibromide, diquat dibromide, saflufenacil, trifludimoxazin, tiafenacil, pyroxasulfone, bicyclopyrone, glufosinate, L-glufosinate, glyphosate, mesotrione, metribuzin, and [3-(2-methoxy-4-prop-1-ynyl-phenyl)-4-oxo-2-bicyclo[3.2.1]oct-2-enyl]methyl carbonate.

In a more preferred composition according to the second aspect of the invention the additional pesticide is a herbicide safener selected from the group consisting of benoxacor, cloquintocet, cyprosulfamide, dichlormid, fenchlorazole, fenclorim, fluxofenim, furilazole, isoxadifen, mefenpyr, metcamifen and oxabetrinil.

In a third aspect of the present invention there is provided a method of controlling weeds at a locus comprising applying to the locus of a weed controlling amount of a composition of the present invention.

In a fourth aspect of the present invention there is provided a method of selectively controlling weeds at a locus comprising crop plants and weeds, said method comprising applying to the locus a weed controlling amount of a composition according to the invention. In a preferred method according to the fourth aspect of the present invention, the crop plant is oil palm, corn, cereals or soya.

In a preferred method according to the fourth aspect of the present invention, the weeds comprise species selected from the group consisting of Amaranthus sp., Ipomoea sp., Erigeron sp., Kochia sp., Borreria sp., Commelina sp., Portulaca sp., Chenopodium sp., Abutilon sp., Stellaria sp., Eleusine sp., Brachiaria sp., Digitaria sp., Echinochloa sp., Setaria sp., Sorghum sp., and Lolium sp.,

In another aspect, there is provided a method for controlling the growth of protoporphyrinogen IX oxidase (PPO) inhibitor herbicide resistant weeds, which comprises applying to the weed, part of the weed, weed propagation material, or the locus of the weed, an effective amount of a composition according to the invention, wherein the PPO-resistant weeds are weeds that are resistant to at least one PPO-inhibiting herbicide, except the compounds of Formula (I).

In another aspect, there is provided a method for controlling the growth of PPO-resistant weeds, which comprises applying to the weed, part of the weed, weed propagation material, or the locus of the weed, an effective amount of a composition according to the invention, wherein the PPO-resistant weeds are weeds that are resistant to at least one PPO-inhibiting herbicide, except the compounds of Formula (I), and have a mutation at amino acid 98, amino acid 210, amino acid 361, and/or amino acid 399 in the gene coding for the protoporphyrinogen oxidase enzyme.

In another aspect, there is provided a method for controlling the growth of PPO-resistant weeds, which comprises applying to the weed, part of the weed, weed propagation material, or the locus of the weed, an effective amount of a composition according to the invention, wherein the PPO-resistant weeds have a mutation at amino acid 98, amino acid 210, and/or amino acid 399 in the gene coding for the protoporphyrinogen oxidase enzyme.

In another aspect, the present invention also relates to use of a composition according to the invention to control weeds that are resistant to other PPO herbicides except the compound of Formula (I), such as flumioxazin, fomesafen, and/or lactofen. The weeds may have been rendered tolerant to PPO herbicides by evolution, by conventional methods of breeding or by genetic engineering. Examples include Amaranthus palmeri and Amaranthus tuberculatus that has evolved resistance to PPO herbicides.

In another aspect, there is provided the use of a composition according to the invention, over the top of crops that are tolerant to PPO inhibitors. As a known PPO-inhibitor, it is obvious that the compound of Formula (Ia) can be used in methods of controlling undesired vegetation in crop plants which are tolerant to protoporphyrinogen oxidase (PPO) inhibitors. Such plants can be obtained, for example, by transforming crop plants with nucleic acids which encode a suitable protoporphyrinogen oxidase, which may contain a mutation in order to make it more resistant to the PPO inhibitor. Examples of such nucleic acids and crop plants are disclosed in WO95/34659, WO97/32011, WO2007/024739, WO2012/080975, WO2013/189984, WO2015/022636, WO2015/022640, WO2015/092706, WO2016/099153, WO2017/023778, WO2017/039969, WO2017/217793, WO2017/217794, WO2018/114759, WO2019/117578, WO2019/117579 and WO2019/118726. In a preferred embodiment, the crop plants which are tolerant to PPO inhibitors comprise a gene encoding for the HemG enzyme H_N90, as disclosed in WO2017/023778 and WO2024/015950. In another preferred embodiment, the crop plants which are tolerant to PPO inhibitors are cotton, corn, and soy.

When active ingredients are combined, the activity to be expected (E) for any given active ingredient combination obeys the so-called Colby Formula and can be calculated as follows (Colby, S. R., Calculating synergistic and antagonistic responses of herbicide combination, Weeds, Vol. 15, pages 20-22; 1967):
ppm=milligrams of active ingredient (a.i.) per liter
X=% action by first active ingredient using p ppm of the active ingredient
Y=% action by second active ingredient sing q ppm of the active ingredient.

According to Colby, the expected action of active ingredients A+B using p+q ppm of active ingredient is represented by the following formula:

E=X+Y−X·/100

If the action actually observed (O) is greater than the expected action E then the action of the combination is super-additive, i.e. there is a synergistic effect. In mathematical terms, synergism corresponds to a positive value for the difference of (O-E). In the case of purely complementary addition of activities (expected activity), said difference (O-E) is zero. A negative value of said difference (O-E) signals a loss of activity compared to the expected activity.

Surprisingly, the combination of the present invention demonstrates additive herbicidal activity, and certain embodiments even exhibit a synergistic effect. Synergistic effect occurs whenever the action of an active ingredient combination is greater than the sum of the actions of the individual components.

Combinations of the invention may also provide for an extended spectrum of activity in comparison to that obtained by each individual component, and/or permit the use of lower rates of the individual components when used in combination to that when used alone, in order to mediate effective herbicidal activity.

In addition, it is also possible that the composition of the invention may show increased crop tolerance, when compared with the effect of the compound A alone. This occurs when the action of an active ingredient combination is less damaging to a useful crop than the action of one of the active ingredients alone.

Where component (A) is a compound of Formula (Ia), Formula (Ia) is referred to as Compound 6 in WO2016/095768. It can be prepared according to Example 1 of WO2016/095768.

As used herein, the term “C₁-C₄alkyl” refers to a straight or branched hydrocarbon chain radical consisting solely of carbon and hydrogen atoms, containing no unsaturation, having from one to four carbon atoms, and which is attached to the rest of the molecule by a single bond. Examples of C₁-C₄alkyl include, but are not limited to, methyl (e.g., CH₃—), ethyl (e.g., CH₃CH₂—), n-propyl, n-butyl, and the isomers thereof, for example, iso-propyl, iso-butyl, sec-butyl, or tert-butyl.

As used herein, the term “C₁-C₄alkylcarbonyl” refers to a radical of the formula —C(O)Ra, where Ra is a C₁-C₄alkyl radical as generally defined above. Examples of C₁-C₄alkylcarbonyl include, but are not limited to, acetyl.

As used herein, the term “C₁-C₂alkylsulfonyl” refers to a radical of the formula —S(O)₂Ra, where Ra is a C₁-C₂alkyl radical as generally defined above. Examples of C₁-C₂alkylsulfonyl include, but are not limited to methylsulfonyl.

Throughout this document the expression “composition” should be interpreted as meaning the various mixtures or combinations of components (A) and (B), for example in a single “ready-mix” form, in a combined spray mixture composed from separate formulations of the single active ingredient components, such as a “tank-mix”, and in a combined use of the single active ingredients when applied in a sequential manner, i.e. one after the other within a reasonably short period, such as a few hours or days. The order of applying components (A) and (B) is not essential for working the present invention. Preferably they are in a single ready-mix form.

The term “herbicide” as used herein means a compound that controls or modifies the growth of plants. The term “herbicidally effective amount” means the quantity of such a compound or combination of such compounds that is capable of producing a controlling or modifying effect on the growth of plants. Controlling or modifying effects include all deviation from natural development, for example killing, retardation, leaf burn, albinism, dwarfing and the like.

The term “locus” as used herein means fields in or on which plants are growing, or where seeds of cultivated plants are sown, or where seed will be placed into the soil. It includes soil, seeds, and seedlings, as well as established vegetation.

The term “plants” refers to all physical parts of a plant, including seeds, seedlings, saplings, roots, tubers, stems, stalks, foliage, and fruits.

The term “plant propagation material” denotes all generative parts of a plant, for example seeds or vegetative parts of plants such as cuttings and tubers. It includes seeds in the strict sense, as well as roots, fruits, tubers, bulbs, rhizomes, and parts of plants.

The term “safener” as used herein means a chemical that when used in combination with a herbicide reduces the undesirable effects of the herbicide on non-target organisms, for example, a safener protects crops from injury by herbicides but does not prevent the herbicide from killing the weeds.

Crops of useful plants in which the composition according to the invention can be used include perennial and annual crops, such as berry plants for example blackberries, blueberries, cranberries, raspberries and strawberries; cereals for example barley, maize (corn), millet, oats, rice, rye, sorghum triticale and wheat; fibre plants for example cotton, flax, hemp, jute and sisal; field crops for example sugar and fodder beet, coffee, hops, mustard, oilseed rape (canola), poppy, sugar cane, sunflower, tea and tobacco; fruit trees for example apple, apricot, avocado, banana, cherry, citrus, nectarine, peach, pear and plum; grasses for example Bermuda grass, bluegrass, bentgrass, centipede grass, fescue, ryegrass, St. Augustine grass and Zoysia grass; herbs such as basil, borage, chives, coriander, lavender, lovage, mint, oregano, parsley, rosemary, sage and thyme; legumes for example beans, lentils, peas and soya beans; nuts for example almond, cashew, ground nut, hazelnut, peanut, pecan, pistachio and walnut; palms for example oil palm; ornamentals for example flowers, shrubs and trees; other trees, for example cacao, coconut, olive and rubber; vegetables for example asparagus, aubergine, broccoli, cabbage, carrot, cucumber, garlic, lettuce, marrow, melon, okra, onion, pepper, potato, pumpkin, rhubarb, spinach and tomato; and vines for example grapes.

Preferably, the compositions of the present invention are used in controlling weeds in oil palm, corn, cereals or soya.

Crops are to be understood as being those which are naturally occurring, obtained by conventional methods of breeding, or obtained by genetic engineering. They include crops which contain so-called output traits (e.g. improved storage stability, higher nutritional value and improved flavour).

Crops are to be understood as also including those crops which have been rendered tolerant to herbicides or classes of herbicides (e.g. ALS-, GS-, EPSPS-, PPO-, ACCase- and HPPD-inhibitors) by conventional methods of breeding or by genetic engineering. An example of a crop that has been rendered tolerant to imidazolinones, e.g. imazamox, by conventional methods of breeding is Clearfield® summer rape (canola). Examples of crops that have been rendered tolerant to herbicides by genetic engineering methods include e.g. glyphosate- and glufosinate-resistant maize varieties commercially available under the trade names RoundupReady® and LibertyLink®.

Crops are also to be understood as being those which have been rendered resistant to harmful insects by genetic engineering methods, for example Bt maize (resistant to European corn borer), Bt cotton (resistant to cotton boll weevil) and also Bt potatoes (resistant to Colorado beetle). Examples of Bt maize are the Bt 176 maize hybrids of NK® (Syngenta Seeds). The Bt toxin is a protein that is formed naturally by Bacillus thuringiensis soil bacteria. Examples of toxins, or transgenic plants able to synthesise such toxins, are described in EP-A-451 878, EP-A-374 753, WO 93/07278, WO 95/34656, WO 03/052073 and EP-A-427 529. Examples of transgenic plants comprising one or more genes that code for an insecticidal resistance and express one or more toxins are KnockOut® (maize), Yield Gard® (maize), NuCOTIN33B® (cotton), Bollgard® (cotton), NewLeaf® (potatoes), NatureGard® and Protexcta®. Plant crops or seed material thereof can be both resistant to herbicides and, at the same time, resistant to insect feeding (“stacked” transgenic events). For example, seed can have the ability to express an insecticidal Cry3 protein while at the same time being tolerant to glyphosate.

Examples of crops that have been rendered tolerant to PPO inhibiting herbicides by genetic engineering are known in the art, for example as described in WO95/34659. Examples of crops that have been rendered tolerant to HPPD inhibiting herbicides by genetic engineering are known in the art, for example as described in WO2011/063411, WO2011/063413, WO2012/082542, WO2012/082548, WO2010/085705 and WO2011/068567.

Compositions of the invention can typically be used to control a wide variety of monocotyledonous and dicotyledonous weed species. Examples of monocotyledonous species that can typically be controlled include Alopecurus sp. (e.g. Alopecurus myosuroides), Avena sp. (e.g. Avena fatua), Brachiaria sp. (e.g. Brachiaria plantaginea), Bromus sp. (e.g. Bromus tectorum), Cyperus sp. (e.g. Cyperus esculentus), Digitaria sp. (e.g. Digitaria sanguinalis), Echinochloa sp. (e.g. Echinochloa crus-galli), Eleusine sp. (e.g. Eleusine indica), Lolium sp. (e.g. Lolium perenne, Lolium multiflorum), Panicum sp. (e.g. Panicum miliaceum), Poa sp. (e.g. Poa annua), Setaria sp. (e.g. Setaria viridis, Setaria fabern) and Sorghum sp. (e.g. Sorghum bicolor). Examples of dicotyledonous species that can be controlled include Abutilon sp. (e.g. Abutilon theophrasth), Amaranthus sp. (e.g. Amaranthus retroflexus, Amaranthus palmen), Bidens sp. (e.g. Bidens Pilosa), Chenopodium sp. (e.g. Chenopodium album), Conyza sp. (e.g. Conyza canadensis), Euphorbia sp. (e.g Euphorbia heterophylla), Galium sp. (e.g. Galium aparine), Ipomoea sp. (e.g. Ipomoea hederacea), Kochia sp. (e.g. Kochia scoparia), Polygonum sp. (e.g. Polygonum convolvulus), Sida sp. (e.g. Sida spinosa), Sinapis sp. (e.g. Sinapis arvensis), Solanum sp. (e.g. Solanum nigrum), Stellaria sp. (e.g. Stellaria media), Veronica sp. (e.g. Veronica persica) and Xanthium sp. (e.g. Xanthium strumarium).

Preferably, the compositions of the present invention are used to control Amaranthus sp., Alopecurus sp., Ipomoea sp., Erigeron sp., Kochia sp., Borreria sp., Commelina sp., Portulaca sp., Chenopodium sp., Abutilon sp., Stellaria sp., Eleusine sp., Brachiaria sp., Digitaria sp., Echinochloa sp., Setaria sp., Sorghum sp., and Lolium sp.

More preferably, the compositions of the present invention are used to control Ipomoea sp., Alopecurus sp., Lolium sp., Echinochloa sp., and Setaria sp. Even more preferably, the compositions of the present invention are used to control Ipomoea hederacea, Alopecurus myosuroides, Lolium perenne, Echinochloa crus-galli, and Setaria faberi. In one aspect, the compositions of the present invention are used to control Ipomoea sp.

In all aspects of the invention, in any particular embodiment, the weeds, e.g. to be controlled and/or growth-inhibited, may be monocotyledonous or dicotyledonous weeds, which are tolerant or resistant to one or more other herbicides for example, HPPD inhibitor herbicides such as mesotrione, PSII inhibitor herbicides such as atrazine or EPSPS inhibitors such as glyphosate. Such weeds include, but are not limited to resistant Amaranthus biotypes.

Compositions of this invention can also be mixed with one or more further pesticides including herbicides [typically different to the herbicides (A) and (B)], fungicides, insecticides, nematocides, bactericides, acaricides, growth regulators, chemosterilants, semiochemicals, repellents, attractants, pheromones, feeding stimulants or other biologically active compounds to form a multi-component pesticide giving an even broader spectrum of agricultural protection.

Preferred herbicides, as an additional mixing partner, are selected from one or more of acetochlor, acifluorfen (including acifluorfen-sodium), aclonifen, ametryn, amicarbazone, aminopyralid, aminotriazole, atrazine, beflubutamid-M, benquitrione, bensulfuron (including bensulfuron-methyl), bentazone, bicyclopyrone, bilanafos, bipyrazone, bispyribac-sodium, bixlozone, broclozone, bromacil, bromoxynil, butachlor, butafenacil, carfentrazone (including carfentrazone-ethyl), cloransulam (including cloransulam-methyl), chlorimuron (including chlorimuron-ethyl), chlorotoluron, chlorsulfuron, cinmethylin, clacyfos, clethodim, clodinafop (including clodinafop-propargyl), clomazone, clopyralid, cyclopyranil, cyclopyrimorate, cyclosulfamuron, cyhalofop (including cyhalofop-butyl), 2,4-D (including the choline salt and 2-ethylhexyl ester thereof), 2,4-DB, desmedipham, dicamba (including the aluminium, aminopropyl, bis-aminopropylmethyl, choline, dichloroprop, diglycolamine, dimethylamine, dimethylammonium, potassium and sodium salts thereof) diclosulam, diflufenican, diflufenzopyr, dimethachlor, dimethenamid-P, dioxopyritrione, diquat dibromide, diuron, epyrifenacil, ethalfluralin, ethofumesate, fenoxaprop (including fenoxaprop-P-ethyl), fenoxasulfone, fenpyrazone, fenquinotrione, fentrazamide, flazasulfuron, florasulam, florpyrauxifen (including florpyrauxifen-benzyl), fluazifop (including fluazifop-P-butyl), flucarbazone (including flucarbazone-sodium), fluchloraminopyr (including fluchloraminopyr-tefuryl), flufenacet, flufenoximacil, flumetsulam, flumioxazin, fluometuron, fomesafen flupyrsulfuron (including flupyrsulfuron-methyl-sodium), fluroxypyr (including fluroxypyr-meptyl), flusulfinam, fomesafen, foramsulfuron, glufosinate (including L-glufosinate and the ammonium salts of both), glyphosate (including the diammonium, isopropylammonium and potassium salts thereof), halauxifen (including halauxifen-methyl), haloxyfop (including haloxyfop-methyl), hexazinone, hydantocidin, icafolin (including icafolin-methyl), imazamox (including R-imazamox), imazapic, imazapyr, imazethapyr, indaziflam, indolauxipyr (including indolauxipyr-cyanomethyl), iodosulfuron (including iodosulfuron-methyl-sodium), iofensulfuron (including iofensulfuron-sodium), ioxynil, iptriazopyrid, isoproturon, isoxaflutole, lancotrione, MCPA, MCPB, mecoprop-P, mesosulfuron (including mesosulfuron-methyl), mesotrione, metamitron, metazachlor, methiozolin, metolachlor, metosulam, metribuzin, metsulfuron, napropamide, nicosulfuron, norflurazon, oxadiazon, oxasulfuron, oxyfluorfen, paraquat dichloride, pendimethalin, penoxsulam, phenmedipham, picloram, pinoxaden, pretilachlor, primisulfuron-methyl, prometryne, propanil, propaquizafop, propyrisulfuron, propyzamide, prosulfocarb, prosulfuron, pyraclonil, pyraflufen (including pyraflufen-ethyl), pyraquinate, pyrasulfotole, pyridate, pyriftalid, pyriflubenzoxim, pyrimisulfan, pyroxasulfone, pyroxsulam, quinclorac, quinmerac, quizalofop (including quizalofop-P-ethyl and quizalofop-P-tefuryl), rimisoxafen, rimsulfuron, saflufenacil, sethoxydim, simazine, S-metalochlor, sulfentrazone, sulfosulfuron, tebuthiuron, tefuryltrione, tembotrione, terbuthylazine, terbutryn, tetflupyrolimet, thiencarbazone, thifensulfuron, tiafenacil, tolpyralate, topramezone, tralkoxydim, triafamone, triallate, triasulfuron, tribenuron (including tribenuron-methyl), triclopyr, trifloxysulfuron (including trifloxysulfuron-sodium), trifludimoxazin, trifluralin, triflusulfuron, tripyrasulfone, 3-(2-chloro-4-fluoro-5-(3-methyl-2,6-dioxo-4-trifluoromethyl-3,6-dihydropyrimidin-1(2H)-yl)phenyl)-5-methyl-4,5-dihydroisoxazole-5-carboxylic acid ethyl ester, 4-hydroxy-1-methoxy-5-methyl-3-[4-(trifluoromethyl)-2-pyridyl]imidazolidin-2-one, 4-hydroxy-1,5-dimethyl-3-[4-(trifluoromethyl)-2-pyridyl]imidazolidin-2-one, 5-ethoxy-4-hydroxy-1-methyl-3-[4-(trifluoromethyl)-2-pyridyl]imidazolidin-2-one, 4-hydroxy-1-methyl-3-[4-(trifluoromethyl)-2-pyridyl]imidazolidin-2-one, 4-hydroxy-1,5-dimethyl-3-[1-methyl-5-(trifluoromethyl)pyrazol-3-yl]imidazolidin-2-one, (4R)₁-(5-tert-butylisoxazol-3-yl)-4-ethoxy-5-hydroxy-3-methyl-imidazolidin-2-one, (1RS,5SR)-3-[2-methoxy-4-(prop-1-yn-1-yl)phenyl]-4-oxobicyclo[3.2.1]oct-2-en-2-yl methyl carbonate, ethyl-2-[[3-[[3-chloro-5-fluoro-6-[3-methyl-2,6-dioxo-4-(trifluoromethyl)pyrimidin-1-yl]-2-pyridyl]oxy]acetate, methyl 2-[2-[2-bromo-4-fluoro-5-[3-methyl-2,6-dioxo-4-(trifluoromethyl)pyrimidin-1-yl]phenoxy]phenoxy]-2-methoxy-acetate, 6-chloro-4-(2,7-dimethyl-1-naphthyl)-5-hydroxy-2-methyl-pyridazin-3-one, (2-fluorophenyl)methyl 6-amino-5-chloro-2-(4-chloro-2-fluoro-3-methoxy-phenyl)pyrimidine-4-carboxylate, 6-amino-5-chloro-2-(4-chloro-2-fluoro-3-methoxy-phenyl)pyrimidine-4-carboxylic acid, methyl 3-[2-chloro-5-[3,6-dihydro-3-methyl-2,6-dioxo-4-(trifluoromethyl)-1(2H)-pyrimidinyl]-4-fluorophenyl]-3a,4,5,6-tetrahydro-6-methyl-6aH-cyclopent[d]isoxazole-6a-carboxylate, 2-[(2-bromo-6-fluoro-phenyl)methoxy]-4-isopropyl-1-methyl-7-oxabicyclo[2.2.1]heptane and (isopropylideneamino) 6-amino-2-(4-chloro-2-fluoro-3-methoxy-phenyl)-5-methoxy-pyrimidine-4-carboxylate.

More preferred herbicides, as an additional mixing partner, are ametryn, atrazine, butafenacil, 2,4-D (including the choline salt and 2-ethylhexyl ester thereof), cloransulam, dicosulam, diuron, flazasulfuron, fluazifop (including fluazifop-P-butyl), flumioxazin, fluometuron, fomesafen, glufosinate, L-glufosinate, glyphosate, indaziflam, isoxaflutole, metribuzin, mesosulfuron, mesotrione, bicyclopyrone, pendamethalin, prometryn, pyroxasulfone, saflufenacil, simazine, sulfentrazone, tiafenacil, terbuthylazine, trifludimoxazin, trifluralin, ethyl 2-[[3-[2-chloro-4-fluoro-5-[3-methyl-2,6-dioxo-4-(trifluoromethyl)pyrimidin-1-yl]phenoxy]-2-pyridyl]oxy]acetate, and [3-(2-methoxy-4-prop-1-ynyl-phenyl)-4-oxo-2-bicyclo[3.2.1]oct-2-enyl]methyl carbonate. Even more preferred herbicides are selected from one or more of atrazine, clethodim, 2,4-D (including the choline salt and 2-ethylhexyl ester thereof), dicamba (including the aluminium, aminopropyl, bis-aminopropylmethyl, choline, dichloroprop, diglycolamine, dimethylamine, dimethylammonium, potassium and sodium salts thereof), diquat dibromide, flazasulfuron, fluazifop (including fluazifop-P-butyl), flumioxazin, fomesafen, glufosinate, L-glufosinate, glyphosate, isoxaflutole, metribuzin, mesosulfuron, mesotrione, bicyclopyrone, paraquat dibromide, pyroxasulfone, saflufenacil, sulfentrazone, tiafenacil, trifludimoxazin, ethyl 2-[[3-[2-chloro-4-fluoro-5-[3-methyl-2,6-dioxo-4-(trifluoromethyl)pyrimidin-1-yl]phenoxy]-2-pyridyl]oxy]acetate, and [3-(2-methoxy-4-prop-1-ynyl-phenyl)-4-oxo-2-bicyclo[3.2.1]oct-2-enyl]methyl carbonate. Most preferred herbicides are selected from the group consisting of paraquat dibromide, diquat dibromide, saflufenacil, trifludimoxazin, tiafenacil, pyroxasulfone, bicyclopyrone, glufosinate, L-glufosinate, glyphosate, mesotrione, metribuzin, and [3-(2-methoxy-4-prop-1-ynyl-phenyl)-4-oxo-2-bicyclo[3.2.1]oct-2-enyl]methyl carbonate.

Similarly compositions of the invention (which includes those comprising one or more additional pesticide as described in the preceding paragraphs) can further include one or more safeners. In particular, the following safeners are especially preferred: AD 67 (MON 4660), benoxacor, cloquintocet (including cloquintocet-mexyl), cyometrinil, cyprosulfamide, dichlormid, dicyclonon, dietholate, fenchlorazole (including fenchlorazole-ethyl), fenclorim, flurazole, fluxofenim, furilazole, furilazome, isoxadifen (including isoxadifen-ethyl), mefenpyr (including mefenpyr-diethyl), mephenate, metcamifen oxabetrinil, naphthalic anhydride (CAS RN 81-84-5), TI-35, N-isopropyl-4-(2-methoxy-benzoylsulfamoyl)-benzamide (CAS RN 221668-34-4) and N-(2-methoxybenzoyl)-4-[(methylaminocarbonyl)amino]benzenesulfonamide, and more preferably benoxacor, cloquintocet, cyprosulfamide, dichlormid, fenchlorazole, fenclorim, fluxofenim, furilazole, isoxadifen, mefenpyr, metcamifen and oxabetrinil. Such safeners may also be used in the form of esters or salts, as mentioned e.g. in The Pesticide Manual, 15th Ed. (BCPC), 2009. Thus, the reference to cloquintocet-mexyl also applies to cloquintocet and to a lithium, sodium, potassium, calcium, magnesium, aluminium, iron, ammonium, quaternary ammonium, sulfonium or phosphonium salt thereof as disclosed in WO02/34048 and the reference to fenchlorazole-ethyl also applies to fenchlorazole, etc.

The compositions of the invention can be applied before or after planting of the crops, before weeds emerge (pre-emergence application) or after weeds emerge (post-emergence application). Where a safener is combined with mixtures of the invention, it is preferred that the mixing ratio of compound (A) to safener is from 100:1 to 1:10, preferably from 20:1 to 1:1.

It is possible that the safener and the compositions of the invention are applied simultaneously. For example, the safener and the composition of the invention might be applied to the locus pre-emergence or might be applied to the crop post-emergence. It is also possible that the safener and the composition of the invention are applied sequentially. For example, the safener might be applied before sowing the seeds as a seed treatment and the composition of the invention might be applied to the locus pre-emergence or might be applied to the crop post-emergence.

However, the skilled person will appreciate that compositions of the invention are particularly useful in non-selective burn-down applications, and as such may also be used to control volunteer or escape crop plants. In such situations, it is clearly not necessary to include a safener in a composition of the invention.

The mass ratio of any two ingredients in each combination is selected as to give the desired, for example, synergistic action. In general, the mass ratio would vary depending on the specific ingredient and how many ingredients are present in the combination. Generally, the mass ratio between any two ingredients in any combination of the present invention, independently of one another, is from 150:1 to 1:150, including from 149:1, 148:2, 147:3, 146:4, 145:5, 144:6, 143:7, 142:8, 141:9, 140:10, 139:11, 138:12, 137:13, 136:14, 135:15, 134:16, 133:17, 132:18, 131:19, 130:20, 129:21, 128:22, 127:23, 126:24, 125:25, 124:26, 123:27, 122:28, 121:29, 120:30, 119:31, 118:32, 117:33, 116:34, 115:35, 114:36, 113:37, 112:38, 111:39, 110:40, 109:41, 108:42, 107:43, 106:44, 105:45, 104:46, 103:47, 102:48, 101:49, 100:50, 99:51, 98:52, 97:53, 96:54, 95:55, 94:56, 93:57, 92:58, 91:59, 90:60, 89:61, 88:62, 87:63, 86:64, 85:65, 84:66, 83:67, 82:68, 81:69, 80:70, 79:71, 78:72, 77:73, 76:74, 75:75, 74:76, 73:77, 72:78, 71:79, 70:80, 69:81, 68:82, 67:83, 66:84, 65:85, 64:86, 63:87, 62:88, 61:89, 60:90, 59:91, 58:92, 57:93, 56:94, 55:95, 54:96, 53:97, 52:98, 51:99, 50:100, 49:101, 48:102, 47:103, 46:104, 45:105, 44:106, 43:107, 42:108, 41:109, 40:110, 39:111, 38:112, 37:113, 36:114, 35:115, 34:116, 33:117, 32:118, 31:119, 30:120, 29:121, 28:122, 27:123, 26:124, 25:125, 24:126, 23:127, 22:128, 21:129, 20:130, 19:131, 18:132, 17:133, 16:134, 15:135, 14:136, 13:137, 12:138, 11:139, 10:140, 9:141, 8:142, 7:143, 6:144, 5:145, 4:146, 3:147, 2:148, to 1:149. Preferred mass ratios between any two components of present invention are from 100:1 to 1:150, more preferably, 50:1 to 1.150, especially 20:1 to 1:150, advantageously 1:8 to 1:150, such as 1:10 to 1:140, for example 1:50 to 1:140. The mixing ratios are understood to include, on the one hand, ratios by mass and also, on other hand, molar ratios.

In a preferred composition according to the invention component (A) is compound of Formula (Ia) or a salt, tautomer or N-oxide thereof, and component (B) is S-metolachlor, wherein the weight ratio of component (A) to component (B) is from 1:1 to 1:150.

In a more preferred composition according to the invention component (A) is compound of Formula (Ia) or a salt, tautomer or N-oxide thereof, and component (B) is S-metolachlor, wherein the weight ratio of component (A) to component (B) is from 1:8 to 1:150.

In an even more preferred composition according to the invention component (A) is compound of Formula (Ia) or a salt, tautomer or N-oxide thereof, and component (B) is S-metolachlor, wherein the weight ratio of component (A) to component (B) is from 1:10 to 1:140.

In a further embodiment, component (A) is compound of Formula (Ia) or a salt, tautomer or N-oxide thereof, and component (B) is S-metolachlor, wherein the weight ratio of component (A) to component (B) is from 1:10 to 1:133.

In a further embodiment, component (A) is compound of Formula (Ia) or a salt, tautomer or N-oxide thereof, and component (B) is S-metolachlor, wherein the weight ratio of component (A) to component (B) is from 1:10 to 1:67.

In further embodiment, component (A) is compound of Formula (Ia) or a salt, tautomer or N-oxide thereof, and component (B) is S-metolachlor, wherein the weight ratio of component (A) to component (B) is from 1:10 to 1:40.

In further embodiment, component (A) is compound of Formula (Ia) or a salt, tautomer or N-oxide thereof, and component (B) is S-metolachlor, wherein the weight ratio of component (A) to component (B) is from 1:20 to 1:133.

In further embodiment, component (A) is compound of Formula (Ia) or a salt, tautomer or N-oxide thereof, and component (B) is S-metolachlor, wherein the weight ratio of component (A) to component (B) is from 1:20 to 1:67.

In further embodiment, component (A) is compound of Formula (Ia) or a salt, tautomer or N-oxide thereof, and component (B) is S-metolachlor, wherein the weight ratio of component (A) to component (B) is from 1:20 to 1:40.

In another embodiment, there is provided a composition of components (A) and (B), wherein component (A) is a compound of Formula (Ia) and component (B) is S-metolachlor, and wherein the weight ratio of components (A) to (B) is 1:10.

In another embodiment, there is provided a composition of components (A) and (B), wherein component (A) is a compound of Formula (Ia) and component (B) is S-metolachlor, and wherein the weight ratio of components (A) to (B) is 1:20.

In another embodiment, there is provided a composition of components (A) and (B), wherein component (A) is a compound of Formula (Ia) and component (B) is S-metolachlor, and wherein the weight ratio of components (A) to (B) is 1:40.

In another embodiment, there is provided a composition of components (A) and (B), wherein component (A) is a compound of Formula (Ia) and component (B) is S-metolachlor, and wherein the weight ratio of components (A) to (B) is 1:67.

In another embodiment, there is provided a composition of components (A) and (B), wherein component (A) is a compound of Formula (Ia) and component (B) is S-metolachlor, and wherein the weight ratio of components (A) to (B) is 1:133.

In another embodiment, there is provided a composition of components (A) and (B), wherein component (A) is a compound of Formula (Ia) and component (B) is S-metolachlor, and wherein the weight ratio of components (A) to (B) is 1:10 to 1:133, and the species to be controlled is Ipomoea hederacea (IPOHE), Alopecurus myosuroides (ALOMY). Lolium perenne (LOLPE), Echinochloa crus-galli (ECHCG), or Setaria faberi (SETFA).

In another embodiment, there is provided a composition of components (A) and (B), wherein component (A) is a compound of Formula (Ia) and component (B) is S-metolachlor, and wherein the weight ratio of components (A) to (B) is 1:20 to 1:133, and the species to be controlled is Ipomoea hederacea (IPOHE), Alopecurus myosuroides (ALOMY). Lolium perenne (LOLPE), Echinochloa crus-galli (ECHCG), or Setaria faberi (SETFA).

In another embodiment, there is provided a composition of components (A) and (B), wherein component (A) is a compound of Formula (Ia) and component (B) is S-metolachlor, and wherein the weight ratio of components (A) to (B) is 1:40 to 1:133, and the species to be controlled is Ipomoea hederacea (IPOHE).

In another embodiment, there is provided a composition of components (A) and (B), wherein component (A) is a compound of Formula (Ia) and component (B) is S-metolachlor, and wherein the weight ratio of components (A) to (B) is 1:10 to 1:67, and the species to be controlled is Ipomoea hederacea (IPOHE), Alopecurus myosuroides (ALOMY). Lolium perenne (LOLPE), Echinochloa crus-galli (ECHCG), or Setaria faberi (SETFA).

In another embodiment, there is provided a composition of components (A) and (B), wherein component (A) is a compound of Formula (Ia) and component (B) is S-metolachlor, and wherein the weight ratio of components (A) to (B) is 1:20 to 1:67, and the species to be controlled is Ipomoea hederacea (IPOHE), Alopecurus myosuroides (ALOMY). Lolium perenne (LOLPE), Echinochloa crus-galli (ECHCG), or Setaria faberi (SETFA).

In another embodiment, there is provided a composition of components (A) and (B), wherein component (A) is a compound of Formula (Ia) and component (B) is S-metolachlor, and wherein the weight ratio of components (A) to (B) is 1:10 to 1:40, and the species to be controlled is Ipomoea hederacea (IPOHE), Alopecurus myosuroides (ALOMY). Lolium perenne (LOLPE), Echinochloa crus-galli (ECHCG), or Setaria faberi (SETFA).

In another embodiment, there is provided a composition of components (A) and (B), wherein component (A) is a compound of Formula (Ia) and component (B) is S-metolachlor, and wherein the weight ratio of components (A) to (B) is 1:20 to 1:40, and the species to be controlled is Ipomoea hederacea (IPOHE), Alopecurus myosuroides (ALOMY). Lolium perenne (LOLPE), Echinochloa crus-galli (ECHCG), or Setaria faberi (SETFA).

In another embodiment, there is provided a composition of components (A) and (B), wherein component (A) is a compound of Formula (Ia) and component (B) is S-metolachlor, and wherein the weight ratio of components (A) to (B) is 1:10 to 1:40, and the species to be controlled is Alopecurus myosuroides (ALOMY). Lolium perenne (LOLPE), Echinochloa crus-galli (ECHCG), or Setaria faberi (SETFA).

In another embodiment, there is provided a composition of components (A) and (B), wherein component (A) is a compound of Formula (Ia) and component (B) is S-metolachlor, and wherein the weight ratio of components (A) to (B) is 1:20 to 1:40, and the species to be controlled is Alopecurus myosuroides (ALOMY). Lolium perenne (LOLPE), Echinochloa crus-galli (ECHCG), or Setaria faberi (SETFA).

In another embodiment, there is provided a composition of components (A) and (B), wherein component (A) is a compound of Formula (Ia) and component (B) is S-metolachlor, and wherein the weight ratio of components (A) to (B) is 1:10 to 1:40, and the species to be controlled is Alopecurus myosuroides (ALOMY). Lolium perenne (LOLPE), or Echinochloa crus-galli (ECHCG).

In another embodiment, there is provided a composition of components (A) and (B), wherein component (A) is a compound of Formula (Ia) and component (B) is S-metolachlor, and wherein the weight ratio of components (A) to (B) is 1:20 to 1:40, and the species to be controlled is Alopecurus myosuroides (ALOMY). Lolium perenne (LOLPE), or Echinochloa crus-galli (ECHCG).

When applied in a composition of the invention component (A) is typically applied at a rate of 25 to 2000 g/ha, more particularly 25, 50, 75, 100, 125, 150, 200, 250, 300, 400, 500, 750, 800, 1000, 1250, 1500, 1800, or 2000 g/ha. Such rates of component (A) are applied typically in association with 5 to 2000 g/ha of component (B), and more specifically in association with component (B) at a rate of 10, 15, 25, 30, 60, 75, 100, 125, 200, 250, 300, 350, 375, 400, 450, 500, 750 or 1000 g/ha.

The Examples described herein illustrate but do not limit the range of rates of components (A) and (B) that may be employed in the invention.

The amount of a composition according to the invention to be applied, will depend on various factors, such as the compounds employed; the subject of the treatment, such as, for example plants, soil or seeds; the type of treatment, such as, for example spraying, dusting or seed dressing; or the application time. In agricultural practice the application rates of the composition according to the invention depend on the type of effect desired, and typically range from 35 to 4000 g of total composition per hectare, and more commonly between 35 and 2000 g/ha. The application is generally made by spraying the composition, typically by tractor mounted sprayer for large areas, but other methods such as dusting (for powders), drip or drench can also be used.

The compositions of the invention can advantageously be used in the below-mentioned formulations (in which case “active ingredient” relates to the respective mixture of compound (A) with a compound (B) or, when a safener is also used, the respective mixture of the compound (A) with a compound (B) and the safener).

The individual components of the composition of the invention may be utilised as the technical active ingredient as produced. More typically however, the compositions according to the invention may be formulated in various ways using formulation adjuvants, such as carriers, solvents and surface-active substances. The formulations can be in various physical forms, e.g. in the form of dusting powders, gels, wettable powders, water-dispersible granules, water-dispersible tablets, effervescent pellets, emulsifiable concentrates, microemulsifiable concentrates, oil-in-water emulsions, oil-flowables, aqueous dispersions, oily dispersions, suspo-emulsions, capsule suspensions, emulsifiable granules, soluble liquids, water-soluble concentrates (with water or a water-miscible organic solvent as carrier), impregnated polymer films or in other forms known e.g. from the Manual on Development and Use of FAO and WHO Specifications for Pesticides, United Nations, First Edition, Second Revision (2010). Such formulations can either be used directly or diluted prior to use. The dilutions can be made, for example, with water, liquid fertilisers, micronutrients, biological organisms, oil or solvents.

The formulations can be prepared e.g. by mixing the active ingredient with the formulation adjuvants in order to obtain compositions in the form of finely divided solids, granules, solutions, dispersions or emulsions. The active ingredients can also be formulated with other adjuvants, such as finely divided solids, mineral oils, oils of vegetable or animal origin, modified oils of vegetable or animal origin, organic solvents, water, surface-active substances or combinations thereof.

The active ingredients can also be contained in very fine microcapsules. Microcapsules contain the active ingredients in a porous carrier. This enables the active ingredients to be released into the environment in controlled amounts (e.g. slow-release). Microcapsules usually have a diameter of from 0.1 to 500 microns. They contain active ingredients in an amount of about from 25 to 95% by weight of the capsule weight. The active ingredients can be in the form of a monolithic solid, in the form of fine particles in solid or liquid dispersion or in the form of a suitable solution. The encapsulating membranes can comprise, for example, natural or synthetic rubbers, cellulose, styrene/butadiene copolymers, polyacrylonitrile, polyacrylate, polyesters, polyamides, polyureas, polyurethane or chemically modified polymers and starch xanthates or other polymers that are known to the person skilled in the art. Alternatively, very fine microcapsules can be formed in which the active ingredient is contained in the form of finely divided particles in a solid matrix of base substance, but the microcapsules are not themselves encapsulated.

The formulation adjuvants that are suitable for the preparation of the compositions according to the invention are known per se. As liquid carriers there may be used: water, toluene, xylene, petroleum ether, vegetable oils, acetone, methyl ethyl ketone, cyclohexanone, acid anhydrides, acetonitrile, acetophenone, amyl acetate, 2-butanone, butylene carbonate, chlorobenzene, cyclohexane, cyclohexanol, alkyl esters of acetic acid, diacetone alcohol, 1,2-dichloropropane, diethanolamine, p-diethylbenzene, diethylene glycol, diethylene glycol abietate, diethylene glycol butyl ether, diethylene glycol ethyl ether, diethylene glycol methyl ether, N,N-dimethylformamide, dimethyl sulfoxide, 1,4-dioxane, dipropylene glycol, dipropylene glycol methyl ether, dipropylene glycol dibenzoate, diproxitol, alkylpyrrolidone, ethyl acetate, 2-ethylhexanol, ethylene carbonate, 1,1,1-trichloroethane, 2-heptanone, alpha-pinene, d-limonene, ethyl lactate, ethylene glycol, ethylene glycol butyl ether, ethylene glycol methyl ether, gamma-butyrolactone, glycerol, glycerol acetate, glycerol diacetate, glycerol triacetate, hexadecane, hexylene glycol, isoamyl acetate, isobornyl acetate, isooctane, isophorone, isopropylbenzene, isopropyl myristate, lactic acid, laurylamine, mesityl oxide, methoxypropanol, methyl isoamyl ketone, methyl isobutyl ketone, methyl laurate, methyl octanoate, methyl oleate, methylene chloride, m-xylene, n-hexane, n-octylamine, octadecanoic acid, octylamine acetate, oleic acid, oleylamine, o-xylene, phenol, polyethylene glycol, propionic acid, propyl lactate, propylene carbonate, propylene glycol, propylene glycol methyl ether, p-xylene, toluene, triethyl phosphate, triethylene glycol, xylenesulfonic acid, paraffin, mineral oil, trichloroethylene, perchloroethylene, ethyl acetate, amyl acetate, butyl acetate, propylene glycol methyl ether, diethylene glycol methyl ether, methanol, ethanol, isopropanol, and alcohols of higher molecular weight, such as amyl alcohol, tetrahydrofurfuryl alcohol, hexanol, octanol, ethylene glycol, propylene glycol, glycerol, N-methyl-2-pyrrolidone and the like.

Suitable solid carriers are, for example, talc, titanium dioxide, pyrophyllite clay, silica, attapulgite clay, kieselguhr, limestone, calcium carbonate, bentonite, calcium montmorillonite, cottonseed husks, wheat flour, soybean flour, pumice, wood flour, ground walnut shells, lignin and similar substances.

A large number of surface-active substances can advantageously be used in both solid and liquid formulations, especially in those formulations which can be diluted with a carrier prior to use. Surface-active substances may be anionic, cationic, non-ionic or polymeric and they can be used as emulsifiers, wetting agents or suspending agents or for other purposes. Typical surface-active substances include, for example, salts of alkyl sulfates, such as diethanolammonium lauryl sulfate; salts of alkylarylsulfonates, such as calcium dodecylbenzenesulfonate; alkylphenol/alkylene oxide addition products, such as nonylphenol ethoxylate; alcohol/alkylene oxide addition products, such as tridecylalcohol ethoxylate; soaps, such as sodium stearate; salts of alkylnaphthalenesulfonates, such as sodium dibutylnaphthalenesulfonate; dialkyl esters of sulfosuccinate salts, such as sodium di(2-ethylhexyl)sulfosuccinate; sorbitol esters, such as sorbitol oleate; quaternary amines, such as lauryltrimethylammonium chloride, polyethylene glycol esters of fatty acids, such as polyethylene glycol stearate; block copolymers of ethylene oxide and propylene oxide; and salts of mono and di-alkylphosphate esters; and also further substances described e.g. in McCutcheon's Detergents and Emulsifiers Annual, MC Publishing Corp., Ridgewood New Jersey (1981).

Further adjuvants that can be used in pesticidal formulations include crystallisation inhibitors, viscosity modifiers, suspending agents, dyes, anti-oxidants, foaming agents, light absorbers, mixing auxiliaries, antifoams, complexing agents, neutralising or pH-modifying substances and buffers, corrosion inhibitors, fragrances, wetting agents, take-up enhancers, micronutrients, plasticisers, glidants, lubricants, dispersants, thickeners, antifreezes, microbicides, and liquid and solid fertilisers.

The formulations according to the invention can include an additive comprising an oil of vegetable or animal origin, a mineral oil, alkyl esters of such oils or mixtures of such oils and oil derivatives. The amount of oil additive in the composition according to the invention is generally from 0.01 to 10%, based on the mixture to be applied. For example, the oil additive can be added to a spray tank in the desired concentration after a spray mixture has been prepared. Preferred oil additives comprise mineral oils or an oil of vegetable origin, for example rapeseed oil, olive oil or sunflower oil, emulsified vegetable oil, alkyl esters of oils of vegetable origin, for example the methyl derivatives, or an oil of animal origin, such as fish oil or beef tallow. Preferred oil additives comprise alkyl esters of C₈C₂₂ fatty acids, especially the methyl derivatives of C₁₂-C₁₈ fatty acids, for example the methyl esters of lauric acid, palmitic acid and oleic acid (methyl laurate, methyl palmitate and methyl oleate, respectively). Many oil derivatives are known from the Compendium of Herbicide Adjuvants, 10^{th} Edition, Southern Illinois University, 2010.

The formulations generally comprise from 0.1 to 99% by weight, especially from 0.1 to 95% by weight, of compounds (A) and (B) and from 1 to 99.9% by weight of a formulation adjuvant which preferably includes from 0 to 25% by weight of a surface-active substance. Whereas commercial products may preferably be formulated as concentrates, the end user will normally employ dilute formulations.

The rates of application vary within wide limits and depend on the nature of the soil, the method of application, the crop plant, the pest to be controlled, the prevailing climatic conditions, and other factors governed by the method of application, the time of application and the target crop. As a general guideline compositions may be applied at a rate of from 1 to 2000 l/ha, especially from 10 to 1000 l/ha.

Preferred formulations can have the following compositions (weight %), wherein the term “active ingredient” refers to the total weight % of the combination of all active ingredients in the composition:

### Emulsifiable Concentrates:

active ingredient: 1 to 95%, preferably 60 to 90%
surface-active agent: 1 to 30%, preferably 5 to 20%
liquid carrier: 1 to 80%, preferably 1 to 35%

### Dusts:

active ingredient: 0.1 to 10%, preferably 0.1 to 5%
solid carrier: 99.9 to 90%, preferably 99.9 to 99%

### Suspension Concentrates:

active ingredient: 5 to 75%, preferably 10 to 50%
water: 94 to 24%, preferably 88 to 30%
surface-active agent: 1 to 40%, preferably 2 to 30%

### Wettable Powders:

active ingredient: 0.5 to 90%, preferably 1 to 80%
surface-active agent: 0.5 to 20%, preferably 1 to 15%
solid carrier: 5 to 95%, preferably 15 to 90%

### Granules:

active ingredient: 0.1 to 30%, preferably 0.1 to 15%
solid carrier: 99.5 to 70%, preferably 97 to 85%

Various aspects and embodiments of the present invention will now be illustrated in more detail by way of example. It will be appreciated that modification of detail may be made without departing from the scope of the invention.

### EXAMPLES

### Formulation Examples

| Wettable powders | a) | b) | c) |
|---|---|---|---|
| active ingredients | 25% | 50% | 75% |
| sodium lignosulfonate | 5% | 5% | — |
| sodium lauryl sulphate | 3% | — | 5% |
| sodium diisobutylnaphthalenesulfonate | — | 6% | 10% |
| phenol polyethylene glycol ether | — | 2% | — |
| (7-8 mol of ethylene oxide) | | | |
| highly dispersed silicic acid | 5% | 10% | 10% |
| Kaolin | 62% | 27% | — |

The combination is thoroughly mixed with the adjuvants and the mixture is thoroughly ground in a suitable mill, affording wettable powders that can be diluted with water to give suspensions of the desired concentration.

| Powders for dry seed treatment | a) | b) | c) |
|---|---|---|---|
| active ingredients | 25% | 50% | 75% |
| light mineral oil | 5% | 5% | 5% |
| highly dispersed silicic acid | 5% | 5% | — |
| Kaolin | 65% | 40% | — |
| Talcum | — | | 20% |

The combination is thoroughly mixed with the adjuvants and the mixture is thoroughly ground in a suitable mill, affording powders that can be used directly for seed treatment.

Emulsifiable concentrate

| | |
|---|---|
| active ingredients | 10% |
| octylphenol polyethylene glycol ether | 3% |
| (4-5 mol of ethylene oxide) | |
| calcium dodecylbenzenesulfonate | 3% |
| castor oil polyglycol ether (35 mol of ethylene oxide) | 4% |
| Cyclohexanone | 30% |
| xylene mixture | 50% |

Emulsions of any required dilution, which can be used in plant protection, can be obtained from this concentrate by dilution with water.

| Dusts | a) | b) | c) |
|---|---|---|---|
| Active ingredients | 5% | 6% | 4% |
| Talcum | 95% | — | — |
| Kaolin | — | 94% | — |
| mineral filler | — | — | 96% |

Ready-for-use dusts are obtained by mixing the combination with the carrier and grinding the mixture in a suitable mill. Such powders can also be used for dry dressings for seed.

Extruded granules

| | |
|---|---|
| Active ingredients | 15% |
| sodium lignosulfonate | 2% |
| Carboxymethylcellulose | 1% |
| Kaolin | 82% |

The combination is mixed and ground with the adjuvants, and the mixture is moistened with water. The mixture is extruded and then dried in a stream of air.

Coated granules

| | |
|---|---|
| Active ingredients | 8% |
| polyethylene glycol (mol. wt. 200) | 3% |
| Kaolin | 89% |

The finely ground combination is uniformly applied, in a mixer, to the kaolin moistened with polyethylene glycol. Non-dusty coated granules are obtained in this manner.

Suspension concentrate

| | |
|---|---|
| active ingredients | 40% |
| propylene glycol | 10% |
| nonylphenol polyethylene glycol ether (15 mol of ethylene oxide) | 6% |
| Sodium lignosulfonate | 10% |
| Carboxymethylcellulose | 1% |
| silicone oil (in the form of a 75% emulsion in water) | 1% |
| Water | 32% |

The finely ground combination is intimately mixed with the adjuvants, giving a suspension concentrate from which suspensions of any desired dilution can be obtained by dilution with water. Using such dilutions, living plants as well as plant propagation material can be treated and protected against infestation by microorganisms, by spraying, pouring or immersion.

Flowable concentrate for seed treatment

| | |
|---|---|
| active ingredients | 40% |
| propylene glycol | 5% |
| copolymer butanol PO/EO | 2% |
| Tristyrenephenole with 10-20 moles EO | 2% |
| 1,2-benzisothiazolin-3-one (in the form of a 20% solution | 0.5% |
| in water) | |
| monoazo-pigment calcium salt | 5% |
| Silicone oil (in the form of a 75% emulsion in water) | 0.2% |
| Water | 45.3% |

The finely ground combination is intimately mixed with the adjuvants, giving a suspension concentrate from which suspensions of any desired dilution can be obtained by dilution with water. Using such dilutions, living plants as well as plant propagation material can be treated and protected against infestation by microorganisms, by spraying, pouring or immersion.

### Slow Release Capsule Suspension

28 Parts of the combination are mixed with 2 parts of an aromatic solvent and 7 parts of toluene diisocyanate/polymethylene-polyphenylisocyanate-mixture (8:1). This mixture is emulsified in a mixture of 1.2 parts of polyvinylalcohol, 0.05 parts of a defoamer and 51.6 parts of water until the desired particle size is achieved. To this emulsion a mixture of 2.8 parts 1,6-diaminohexane in 5.3 parts of water is added. The mixture is agitated until the polymerization reaction is completed. The obtained capsule suspension is stabilized by adding 0.25 parts of a thickener and 3 parts of a dispersing agent. The capsule suspension formulation contains 28% of the active ingredients. The medium capsule diameter is 8-15 microns. The resulting formulation is applied to seeds as an aqueous suspension in an apparatus suitable for that purpose.

Biological Efficacy Tests Seeds of a variety of test species are sown in standard soil in pots (Ipomoea hederacea (IPHOE), Alopecurus myosuroides (ALOMY), Lolium perenne (LOLPE), Echinochloa crus-galli (ECHCG), and Setaria faberi (SETFA)), and cultivated under controlled conditions in a glasshouse (at 24/16° C., day/night; 14 hours light; 65% humidity), the plants are sprayed with an aqueous spray solution derived from the dissolution of the test compound or composition in acetone and IF50 (11.12% Emulsogen EL360 TM+44.44% N-methylpyrrolidone+44.44% Dowanol DPM glycol ether) which was then diluted to the required concentration using 0.2% Genapol X080 (CAS No. 9043-30-5) in water as the diluent. Test compounds or compositions are applied at the rates stated. The test plants are then grown in a glasshouse under controlled conditions in a glasshouse (at 24/16° C., day/night; 14 hours light; 65% humidity) and watered twice daily. After 14 days, the test is evaluated for the percentage damage caused to the plant (100=total damage to plant; 0=no damage to plant), and the result are shown below in tables B1 to B5.

TABLE B1
Post-emergence efficacy for a composition of the compound of formula
(Ia) and S-metolachlor against Ipomoea hederacea (IPOHE)

| Com- | | Ratio | | | |
|---|---|---|---|---|---|
| pound | S-metolachlor | com- | Observed | Expected | |
| (Ia) (A) | (B) | pound | Activity | Activity | Observed − |
| (g/Ha) | (g/Ha) | (A):(B) | (%) | (%) | Expected |
| 0.9375 | — | — | 84.8 | — | — |
| — | 62.5 | — | 5.0 | — | — |
| — | 125 | — | 7.5 | — | — |
| 0.9375 | 37.5 | 1:40 | 92.0 | 82.5 | 9.5 |
| 0.9375 | 662.5 | 1:67 | 98.5 | 85.5 | 13.0 |
| 0.9375 | 125 | 1:133 | 96.0 | 85.9 | 10.1 |

TABLE B2
Post-emergence efficacy for a composition of
the compound of formula (Ia) and S-metolachlor
against Alopecurus myosuroides (ALOMY)

| Com- | | Ratio | | | |
|---|---|---|---|---|---|
| pound | S-metolachlor | com- | Observed | Expected | |
| (Ia) (A) | (B) | pound | Activity | Activity | Observed − |
| (g/Ha) | (g/Ha) | (A):(B) | (%) | (%) | Expected |
| 1.875 | — | — | 10.0 | — | — |
| 3.75 | — | — | 27.5 | — | — |
| 7.5 | — | — | 42.5 | — | — |
| 15 | — | — | 60.0 | — | — |
| — | 18.75 | — | 0.0 | — | — |
| — | 37.5 | — | 10.0 | — | — |
| — | 75 | — | 0.0 | — | — |
| — | 150 | — | 27.5 | — | — |
| — | 300 | — | 45.0 | — | — |
| 1.875 | 18.75 | 1:10 | 12.5 | 10.0 | 2.5 |
| 7.5 | 75 | 1:10 | 57.5 | 42.5 | 15.0 |
| 15 | 150 | 1:10 | 95.0 | 71.0 | 24.0 |
| 1.875 | 37.5 | 1:20 | 25.0 | 19.0 | 6.0 |
| 7.5 | 150 | 1:20 | 67.5 | 58.3 | 9.2 |
| 15 | 300 | 1:20 | 80.0 | 78.0 | 2.0 |
| 1.875 | 75 | 1:40 | 30.0 | 10.0 | 20.0 |
| 3.75 | 150 | 1:40 | 65.0 | 47.4 | 17.6 |

TABLE B3
Post-emergence efficacy for a composition of the compound of formula
(Ia) and S-metolachlor against Lolium perenne (LOLPE)

| Com- | | Ratio | | | |
|---|---|---|---|---|---|
| pound | S-metolachlor | com- | Observed | Expected | |
| (Ia) (A) | (B) | pound | Activity | Activity | Observed − |
| (g/Ha) | (g/Ha) | (A):(B) | (%) | (%) | Expected |
| 1.875 | — | — | 0.0 | — | — |
| 3.75 | — | — | 12.5 | — | — |
| 7.5 | — | — | 42.5 | — | — |
| 15 | — | — | 50.0 | — | — |
| — | 18.75 | — | 45.0 | — | — |
| — | 37.5 | — | 60.0 | — | — |
| — | 75 | — | 70.0 | — | — |
| — | 150 | — | 67.5 | — | — |
| — | 300 | — | 80.0 | — | — |
| 1.875 | 18.75 | 1:10 | 55.0 | 45.0 | 10.0 |
| 3.75 | 37.5 | 1:10 | 93.5 | 65.0 | 28.5 |
| 7.5 | 75 | 1:10 | 96.5 | 82.8 | 13.8 |
| 15 | 150 | 1:10 | 100.0 | 83.8 | 16.3 |
| 1.875 | 37.5 | 1:20 | 67.5 | 60.0 | 7.5 |
| 3.75 | 75 | 1:20 | 82.5 | 73.8 | 8.8 |
| 7.5 | 150 | 1:20 | 98.5 | 81.3 | 17.2 |
| 15 | 300 | 1:20 | 100.0 | 90.0 | 10.0 |
| 1.875 | 75 | 1:40 | 72.5 | 70.0 | 2.5 |
| 3.75 | 150 | 1:40 | 87.5 | 71.6 | 15.9 |
| 7.5 | 300 | 1:40 | 98.5 | 88.5 | 10.0 |

TABLE B4
Post-emergence efficacy for a composition of the compound of formula
(Ia) and S-metolachlor against Echinochloa crus-galli (ECHCG)

| Com- | | Ratio | | | |
|---|---|---|---|---|---|
| pound | S-metolachlor | com- | Observed | Expected | |
| (Ia) (A) | (B) | pound | Activity | Activity | Observed − |
| (g/Ha) | (g/Ha) | (A):(B) | (%) | (%) | Expected |
| 1.875 | — | — | 15.0 | — | — |
| 3.75 | — | — | 37.5 | — | — |
| 7.5 | — | — | 99.0 | — | — |
| — | 18.75 | — | 75.0 | — | — |
| — | 37.5 | — | 85.0 | — | — |
| — | 75 | — | 85.0 | — | — |
| 1.875 | 18.75 | 1:10 | 87.5 | 78.8 | 8.8 |
| 7.5 | 75 | 1:10 | 95.0 | 90.6 | 4.4 |
| 1.875 | 37.5 | 1:20 | 95.0 | 87.3 | 7.8 |
| 3.75 | 75 | 1:20 | 96.0 | 90.6 | 5.4 |
| 1.875 | 75 | 1:40 | 92.5 | 87.3 | 5.3 |

TABLE B5
Post-emergence efficacy for a composition of the compound of formula
(Ia) and S-metolachlor against Setaria faberi (SETFA)

| Com- | | Ratio | | | |
|---|---|---|---|---|---|
| pound | S-metolachlor | com- | Observed | Expected | |
| (Ia) (A) | (B) | pound | Activity | Activity | Observed − |
| (g/Ha) | (g/Ha) | (A):(B) | (%) | (%) | Expected |
| 1.875 | — | — | 55.0 | — | — |
| 3.75 | — | — | 67.5 | — | — |
| — | 37.5 | — | 72.5 | — | — |
| — | 75 | — | 82.5 | — | — |
| — | 150 | — | 85.0 | — | — |
| 1.875 | 37.5 | 1:20 | 95.0 | 87.6 | 7.4 |
| 3.75 | 75 | 1:20 | 98.5 | 94.3 | 4.2 |
| 1.875 | 75 | 1:40 | 95.0 | 92.1 | 2.9 |
| 3.75 | 150 | 1:40 | 98.5 | 95.1 | 3.4 |

1. A herbicidal composition comprising a mixture of components (A) and (B) as active ingredients, wherein component (A) is a compound of formula (I): 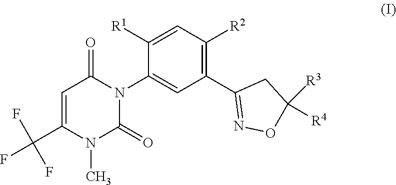
wherein
R^{r} is selected from hydrogen, chloro and fluoro;
R² is selected from chloro and bromo;
R³ is selected from CO₂R⁵ and CH₂OR⁶;
R⁴ is selected from H, CH₃— and CH₃CH₂—;
R⁵ is selected from H, CH₃—, CH₃CH₂—, CH₃CH₂CH₂—, CH₃CH₂CH₂CH₂—, (CH₃)₂CH—, (CH₃)₂CHCH₂—, (CH₃)₃C—, CF₃CH₂—, allyl, propargyl, CH₃OCH₂CH₂—, C₂H₅OCH₂CH₂—, CH₃CO₂CH₂CH₂— and tetrahydrofuranmethyl;
R⁶ is selected from C₁-C₄alkylcarbonyl, cyclopropylcarbonyl, and C₁-C₂alkylsulfonyl;
or an agrochemically acceptable salt thereof; and
component (B) is S-metolachlor or agrochemically acceptable ester or salt thereof.

2. A herbicidal composition according to claim 1, wherein the compound of Formula (I) is a compound of Formula (Ia):

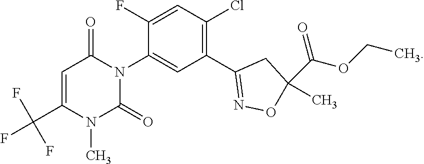 [SMILES: CCOC(=O)C1(C)CC(c2cc(-n3c(=O)cc(C(F)(F)F)n(C)c3=O)c(F)cc2Cl)=NO1]

3. A herbicidal composition according to claim 1, wherein the weight ratio of component (A) to component (B) is from 1:10 to 1:140.

4. A herbicidal composition according to claim 1, wherein the weight ratio of component (A) to component (B) is from 1:10 to 1:133.

5. A herbicidal composition according to claim 1, wherein the weight ratio of component (A) to component (B) is from 1:20 to 1:133.

6. A herbicidal composition according to claim 1, further comprising at least one additional pesticide.

7. A herbicidal composition according to claim 6, wherein the additional pesticide is a herbicide or herbicide safener.

8. A herbicidal composition according to claim 7, wherein the herbicide is selected from the group consisting of paraquat dibromide, diquat dibromide, saflufenacil, trifludimoxazin tiafenacil, pyroxasulfone, bicyclopyrone, glufosinate, L-glufosinate, glyphosate, mesotrione, metribuzin, and [3-(2-methoxy-4-prop-1-ynyl-phenyl)-4-oxo-2-bicyclo[3.2.1]oct-2-enyl]methyl carbonate.

9. A herbicidal composition according to claim 7, wherein the herbicide safener is selected from the group consisting of benoxacor, cloquintocet, cyprosulfamide, dichlormid, fenchlorazole, fenclorim, fluxofenim, furilazole, isoxadifen, mefenpyr, metcamifen and oxabetrinil.

10. A method of controlling weeds at a locus comprising applying to the locus of a weed controlling amount of a herbicidal composition according to claim 1.

11. A method of selectively controlling weeds at a locus comprising crop plants and weeds, said method comprising applying to the locus a weed controlling amount of a herbicidal composition according to claim 1.

12. A method according to claim 11, wherein the weeds are PPO-resistant weeds that are resistant to at least one PPO-inhibiting herbicide, except the compounds of Formula (I).

13. A method according to claim 12, wherein the PPO-resistant weeds have a mutation at amino acid 98, amino acid 210, amino acid 361, and/or amino acid 399 in the gene coding for the protoporphyrinogen oxidase enzyme.

14. A method according to claim 10, wherein the weeds comprise species selected from the group consisting of Amaranthus sp., Alopecurus sp., Ipomoea sp., Erigeron sp., Kochia sp., Borreria sp., Commelina sp., Portulaca sp., Chenopodium sp., Abutilon sp., Stellaria sp., Eleusine sp., Brachiaria sp., Digitaria sp., Echinochloa sp., Setaria sp., Sorghum sp., and Lolium sp.

15. Use of a composition according to claim 1 over crops that are tolerant to PPO-inhibitor herbicides.
